(19) United States
(12) Patent Application Publication
(10) Pub. No.: US 2022/0286069 A1
(43) Pub. Date: Sep. 8, 2022

(54) GENERATOR CONTROL DEVICE

(71) Applicant: Mitsubishi Electric Corporation, Tokyo (JP)

(72) Inventors: Masahiro NAKAJIMA, Tokyo (JP); Junya SASAKI, Tokyo (JP)

(73) Assignee: Mitsubishi Electric Corporation, Tokyo (JP)

(21) Appl. No.: 17/645,707

(22) Filed: Dec. 22, 2021

(30) Foreign Application Priority Data
Mar. 8, 2021 (JP) 2021-035997

(51) Int. Cl. H02P 9/30; H02P 9/48; H02J 7/24; H02K 11/25

(52) U.S. Cl. CPC H02P 9/305; H02P 9/48; H02J 7/243; H02K 11/25; H02P 2101/45

(57) ABSTRACT

To provide a generator control device that, even when communication with an external control device is interrupted, evaluates independently, and can increase an amount of power generated so that a drop in DC voltage can be restricted preemptively, while restricting a fluctuation of rotational speed. A generator control device determines that a voltage drop prediction time control is executed when it is predicted that a drop of the DC voltage will be large; generates a rectangular pulse wave such that a duty ratio increases gradually during the excitation time when determining that the excitation control rotational speed condition was fulfilled, and the voltage drop prediction time control is executed; and changes the duty ratio so that the detected value of the DC voltage nears the increased target voltage when determining that the excitation control rotational speed condition was not fulfilled, and the voltage drop prediction time control is executed.

### INCORPORATION BY REFERENCE

The disclosure of Japanese Patent Application No. 2021-35997 filed on Mar. 8, 2021 including its specification, claims and drawings, is incorporated herein by reference in its entirety.

### BACKGROUND

The present disclosure relates to a generator control device.

A generator control device that controls a generator that generates power using a driving force of an engine is already known. According to technology of JP 2010-114966 A, a battery control device is configured in such a way as to convey a command to increase an amount of power generated to a generator control device when a drop in battery voltage is large.

According to technology of JP 2011-229219 A, an external control device is configured in such a way as to convey a control command value relating to an excitation control that causes a field winding current of a generator to increase gradually to a generator control device. Further, according to the technology of JP 2011-229219 A, the generator control device is configured in such a way as to, when communication with the external control device is interrupted, cause a control command value received from the external control device before the communication interruption to gradually change to a default value.

According to technology of H02-184300 A, a generator control device is configured in such a way as to carry out an excitation control that causes a field winding current of a generator to increase gradually when a direct current voltage output from the generator drops below a target voltage with an engine rotational speed in a low state, thereby causing the direct current voltage to increase while restricting a fluctuation of the engine rotational speed.

### SUMMARY

However, the technologies of JP 2010-114966 A and JP 2011-229219 A are such that when communication with the external control device is interrupted, the generator control device becomes independent, and cannot carry out an appropriate control. Also, the technology of H02-184300 A is such that the excitation control is executed, and the amount of power generated gradually caused to increase, after the direct current voltage drops below the target voltage, because of which there is a problem in that an amount by which the direct current voltage drops increases.

Therefore, the present disclosure has an object of providing a generator control device such that, even when communication with an external control device is interrupted, the generator control device evaluates independently, and can cause an amount of power generated to increase in such a way that a drop in direct current voltage can be restricted preemptively, while restricting a fluctuation of rotational speed.

A generator control device according to the present disclosure is a generator control device that controls a generator that generates direct current power, the generator control device including:

a voltage detecting circuit that detects a direct current voltage output from the generator;

a rotational speed detecting circuit that detects a rotational speed of the generator;

a temperature detecting circuit that detects a temperature of the generator;

a communication circuit that carries out communication with an external control device;

a target voltage receiving and setting unit that sets a target voltage indicated by a command value received from the external control device;

an excitation time receiving and setting unit that sets an excitation time indicated by a command value received from the external control device;

a voltage drop predicting unit that determines that a voltage drop prediction time control is to be executed when it is predicted, based on a detected value of the direct current voltage, a detected value of the rotational speed, and a detected value of the temperature, that a drop of the direct current voltage will be large;

a target voltage correcting unit that causes the target voltage set by the target voltage receiving and setting unit to increase when it has been determined that the voltage drop prediction time control is to be executed;

a rotational speed determining unit that determines that a rotational speed condition for executing an excitation control has been fulfilled when the detected value of the rotational speed is equal to or lower than a preset excitation execution determination value, and determines that the rotational speed condition for executing the excitation control has not been fulfilled when the detected value of the rotational speed is greater than the excitation execution determination value;

an excitation time correcting unit that causes the excitation time set by the excitation time receiving and setting unit to change based on the detected value of the direct current voltage, the detected value of the rotational speed, and the detected value of the temperature;

an excitation control unit that generates a rectangular pulse wave such that a duty ratio that turns on an energization of a field winding included in the generator increases gradually during the excitation time when it has been determined that the excitation control rotational speed condition has been fulfilled, and has been determined that the voltage drop prediction time control is to be executed;

a voltage control unit that causes the duty ratio to change in such a way that the detected value of the direct current voltage nears the target voltage increased by the target voltage correcting unit when it has been determined that the excitation control rotational speed condition has not been fulfilled, and has been determined that the voltage drop prediction time control is to be executed, and generates a rectangular pulse wave of the duty ratio; and

an on/off circuit that turns an energization of the field winding on and off in accordance with a turning on and off of the rectangular pulse wave generated by the excitation control unit or the voltage control unit.

According to the generator control device according to the present disclosure, the generator control device, without depending on an external control device, independently determines whether or not it is predicted that a drop of a direct current voltage will be large, and executes a voltage drop prediction time control, because of which the drop of the direct current voltage can be restricted preemptively, regardless of whether or not communication with the external control device is interrupted. The generator control device independently carries out an excitation control when a rotational speed is equal to or lower than an excitation execution determination value and it is predicted that a drop of the direct current voltage will be large, causing a duty ratio to increase gradually, whereby an amount of power generated can be caused to increase gradually, because of which the drop of the direct current voltage can be restricted preemptively while restricting a decrease of the rotational speed. At this time, the generator control device independently causes an excitation time received from the external control device to change based on a detected value of the direct current voltage, a detected value of the rotational speed, and a detected value of a generator temperature, because of which an appropriate excitation time such that the drop of the direct current voltage can be restricted while restricting a decrease of the rotational speed can be set, without depending on communication with the external control device. Meanwhile, when the rotational speed is greater than the excitation execution determination value and it is predicted that a drop of the direct current voltage will be large, the generator control device independently causes the target voltage received from the external control device to increase, and carries out a voltage control based on the increased target voltage, whereby the duty ratio can be caused to increase, and the drop of the direct current voltage can be restricted preemptively.

### BRIEF DESCRIPTION OF DRAWINGS

FIG. 1 is a schematic configuration drawing of a generator and a generator control device according to a first embodiment.

FIG. 2 is a schematic block drawing of a control circuit according to the first embodiment.

FIG. 3 is a schematic hardware configuration drawing of the control circuit according to the first embodiment.

FIG. 4 is a time chart illustrating a voltage drop prediction time control end determination according to an end determination time according to the first embodiment.

FIG. 5 is a time chart illustrating a voltage drop prediction time control end determination according to an end determination voltage according to the first embodiment.

FIG. 6 is a time chart illustrating a voltage drop prediction time control end determination according to a target voltage before being increased according to the first embodiment.

FIG. 7 is a drawing illustrating an excitation time change according to the first embodiment.

FIG. 8 is a flowchart illustrating a process of the generator control device according to the first embodiment.

FIG. 9 is a time chart illustrating control behavior according to the first embodiment.

FIG. 10 is a time chart illustrating control behavior according to the first embodiment.

### DETAILED DESCRIPTION OF THE EMBODIMENTS

### 1. First Embodiment

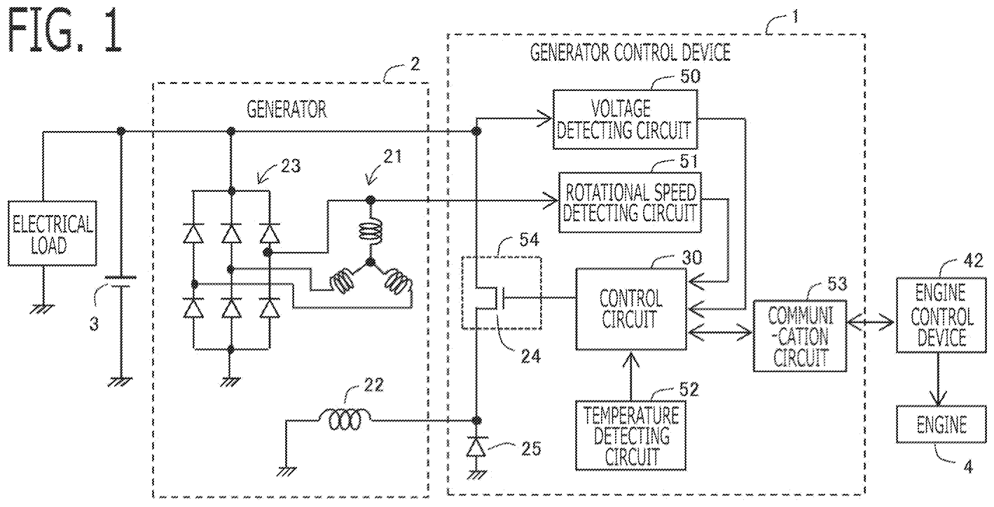

A generator control device 1 that controls a generator 2, which generates direct current power, according to a first embodiment will be described, with reference to the drawings. FIG. 1 is a schematic configuration drawing of the generator 2, the generator control device 1, an engine 4, and an engine control device 42. These components are mounted in a vehicle, and the engine 4 is a driving power source of a wheel.

### 1-1. Generator 2

The generator 2 is such that a three-phase winding 21 is provided in a stator of the generator 2, and a field winding 22 is provided in a rotor. A rotary shaft of the rotor of the generator 2 is coupled to a crankshaft of the engine 4 via a coupling mechanism such as a pulley and belt mechanism. Power is generated by a rotational driving force of the engine 4.

The generator 2 includes a rectifying circuit 23 that rectifies three phases of alternating current power output from the three-phase winding 21, thereby converting the alternating current power into direct current power. The rectifying circuit 23 is a three-phase full-wave diode rectifying circuit wherein three sets of two diodes connected in series are provided. A connection point of the two diodes in each phase is connected to a winding of each phase. A terminal on a positive electrode side of the rectifying circuit 23 is connected to a positive electrode side of a direct current power source 3, such as a battery, and a terminal on a negative electrode side of the rectifying circuit 23 is connected to a negative electrode side (a ground) of the direct current power source 3.

### 1-2. Generator Control Device 1

The generator control device 1 includes a voltage detecting circuit 50, a rotational speed detecting circuit 51, a temperature detecting circuit 52, a communication circuit 53, an on/off circuit 54, a control circuit 30, and the like.

The voltage detecting circuit 50 is a circuit for detecting a direct current voltage Vdc output from the generator 2. The voltage detecting circuit 50 is connected to the terminal on the positive electrode side of the rectifying circuit 23, and detects a potential of the positive electrode side terminal. An output signal of the voltage detecting circuit 50 is input into the control circuit 30.

The rotational speed detecting circuit 51 is a circuit for detecting a rotational speed of the generator 2. In the present embodiment, the rotational speed detecting circuit 51 is connected to the winding of any one phase of the three-phase winding 21. The rotational speed detecting circuit 51 compares a potential of an output terminal of the winding of one phase and a preset potential, and generates and outputs a pulse signal. An output signal of the rotational speed detecting circuit. 51 is input into the control circuit 30.

The on/off circuit 54 is a circuit that turns on and off an energization of the field winding 22 in accordance with a turning on and off of a rectangular pulse wave generated by the control circuit 30 (an excitation control unit 37 or a voltage control unit 38). The on/off circuit 54 has a switching element 24. The field winding 22 is connected in series to the direct current power source 3 via the switching element 24. When the rectangular pulse wave is in an on-state, the switching element 24 is in an on-state, and the direct current voltage Vdc is applied to the field winding 22. When the rectangular pulse wave is in an off-state, the switching element 24 is in an off-state, and no direct current voltage Vdc is applied to the field winding 22.

When a duty ratio Don of the rectangular pulse wave increases, a current flowing to the field winding 22 increases, power generated by the generator 2 increases, and the direct current voltage Vdc increases. Meanwhile, when the duty ratio Don of the rectangular pulse wave decreases, the current flowing to the field winding 22 decreases, power generated by the generator 2 decreases, and the direct current voltage Vdc decreases. When the duty ratio Don of the rectangular pulse wave increases, a regenerative torque increases, and a load torque conveyed to the engine 4 increases.

A MOSFET (Metal-Oxide-Semiconductor Field-Effect Transistor), an IGBT (Insulated Gate Bipolar Transistor), or the like, is used as the switching element 24. A gate terminal of the switching element 24 is connected to the control circuit 30. A rectifying diode 25 is connected in parallel with the field winding 22, and causes the current flowing to the field winding 22 to be rectified when the switching element 24 is in an off-state.

The temperature detecting circuit 52 is a circuit that detects a temperature of the generator 2. The temperature detecting circuit 52 is attached to a place to which heat of the generator 2 is transferred. In the present embodiment, the generator control device 1 is provided neighboring the generator 2, and heat of the generator 2 is transferred, because of which the temperature detecting circuit 52 is provided in an interior of the generator control device 1.

The communication circuit 53 is a circuit that carries out communication with an external control device. The communication circuit 53 carries out a communication of data based on a communication protocol (for example, an LIN (Local Interconnect Network) or a CAN (Controller Area Network) with the external control device via a communication line. The communication circuit 53 is connected to the control circuit 30, transmits data received from the external control device to the control circuit 30, and transmits data transmitted from the control circuit 30 to the external control device. In the present embodiment, the external control device is the engine control device 42. The external control device may be a control device other than the engine control device 42, for example, an integrated control device that comprehensively controls a vehicle drive system.

### 1-2-1. Control Circuit 30

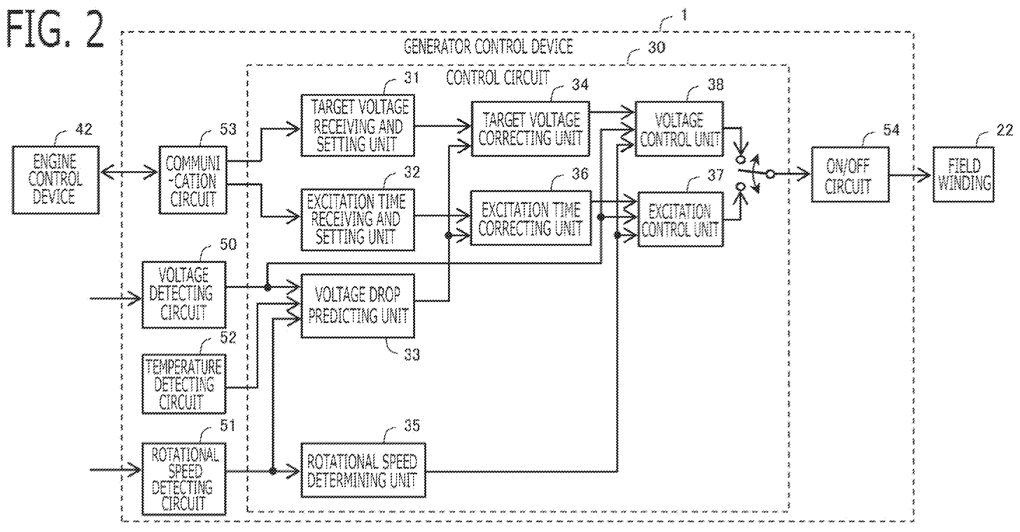

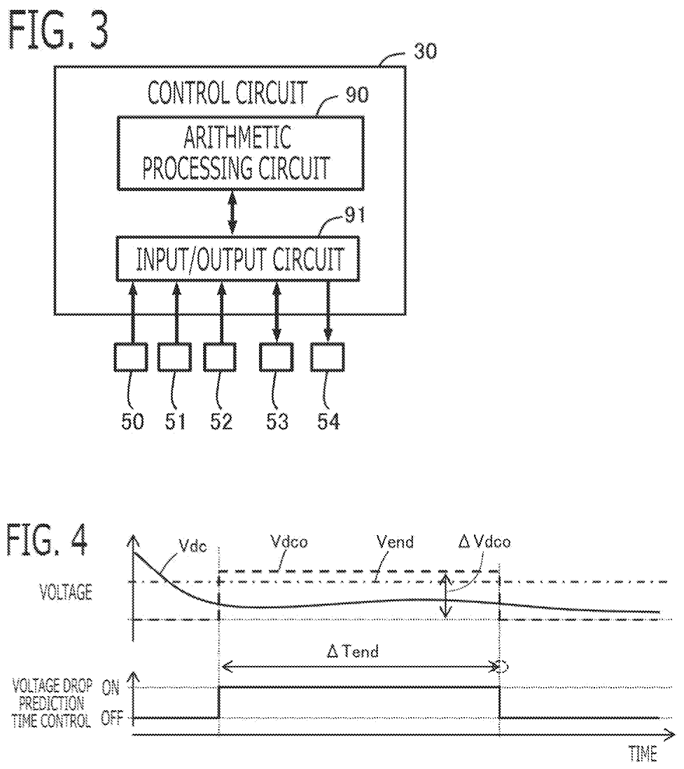

As shown in FIG. 2, the control circuit 30 includes functional units such as a target voltage receiving and setting unit 31, an excitation time receiving and setting unit 32, a voltage drop predicting unit 33, a target voltage correcting unit 34, a rotational speed determining unit 35, an excitation time correcting unit 36, the excitation control unit 37, and the voltage control unit 38. Each functional unit of the control circuit 30 is realized by a processing circuit included in the control circuit 30. For example, an arithmetic processing circuit 90 such as an IC (Integrated Circuit), an ASIC (Application-Specific Integrated Circuit), an FPGA (Field Programmable Gate Array), a CPU (Central Processing Unit), a memory, a kind of logic circuit, or a kind of signal processing circuit, is included as the processing circuit, as shown in FIG. 3. A multiple of the same kind of component or different kinds of component may be included as the arithmetic processing circuit 90, and processes may be executed by being divided among the components. An input/output circuit 91, into and from which an external signal is input and output, is included as a processing circuit. An analog-to-digital converter, a drive circuit, a communication circuit, and the like, are included in the input/output circuit 91, and the voltage detecting circuit 50, the rotational speed detecting circuit 51, the temperature detecting circuit 52, the communication circuit 53, the on/off circuit 54, and the like, are connected to the input/output circuit 91. A target voltage increase amount, various kinds of determination value, various kinds of default value, and setting data such as map data, used by the functional units are stored in a memory such as a ROM, or are set as thresholds or output values of the logic circuit.

The control circuit 30 detects the direct current voltage Vdc based on an output signal of the voltage detecting circuit 50. Also, the control circuit 30 detects a rotational speed Vg of the rotor of the generator 2 based on an output signal of the rotational speed detecting circuit 51. In the present embodiment, the control circuit 30 detects the rotational speed Vg of the generator 2 based on a cycle of a pulse signal output from the rotational speed detecting circuit 51. The rotational speed Vg of the generator 2 is proportional to a rotational speed of the engine 4. The control circuit 30 detects a generator temperature Tg based on an output signal of the temperature detecting circuit 52. The control circuit 30 receives data received by the communication circuit. 53 from the external control device from the communication circuit 53. The control circuit 30 transfers data to be transmitted to the external control device to the communication circuit 53.

### Target Voltage Receiving and Setting Unit 31

The target voltage receiving and setting unit 31 sets a target voltage Vdco indicated by a target voltage command value received from the external control device (the engine control device 42 in this example) via the communication circuit 53. When no target voltage command value is received from the external control device, the target voltage receiving and setting unit 31 sets a preset default value as the target voltage Vdco.

### Excitation Time Receiving and Setting Unit 32

The excitation time receiving and setting unit 32 sets an excitation time Tin indicated by an excitation time command value received from the external control device (the engine control device 42 in this example) via the communication circuit 53. When no excitation time command value is received from the external control device, the target voltage receiving and setting unit 31 sets a preset default value as the excitation time Tin.

The engine control device 42 sets an excitation time command value indicating the excitation time Tin based on an operational state such as the temperature Tg of the generator 2, the rotational speed of the engine, a state of an electrical load to which power is supplied from the battery, and a battery voltage, and transfers the command value to the generator control device 1.

In the present embodiment, the excitation time Tin indicated by an excitation time command value received from the external control device changes stepwisely. In the present embodiment, the excitation time command value is 3-bit digital data, and the excitation time Tin changes stepwisely every time the command value changes by 1 bit. The external control device causes the excitation time command value to change stepwisely in 1-bit units, and transfers the excitation time command value to the generator control device 1. The external control device may cause the excitation time command value to change stepwisely in units of plural bits and transfer the command value to the generator control device 1.

### Voltage Drop Predicting Unit 33

When it is predicted, based on a detected value of the direct current voltage Vdc, a detected value of the rotational speed Vg, and a detected value of the generator temperature Tg, that a drop of the direct current voltage Vdc will be large, the voltage drop predicting unit 33 determines that a voltage drop prediction time control is to be executed.

The voltage drop predicting unit 33 determines whether or not it is predicted that a drop of the direct current voltage Vdc will be large based on a derivative value of the detected value of the direct current voltage Vdc, a derivative value of the detected value of the rotational speed Vg, and a derivative value of the detected value of the generator temperature Tg. The voltage drop predicting unit 33 divides an amount of change in each detected value in a unit time by the unit time, thereby calculating the derivative value of each detected value.

When the derivative value of the detected value of the direct current voltage Vdc drops below a voltage determination value preset to be a negative value, the voltage drop predicting unit. 33 determines that it is predicted that the drop of the direct current voltage Vdc will be large. When a speed at which the direct current voltage Vdc drops is high, it can be predicted that the drop of the direct current voltage Vdc will be large.

When the derivative value of the detected value of the rotational speed Vg drops below a speed determination value preset to be a negative value, the voltage drop predicting unit 33 determines that it is predicted that the drop of the direct current voltage Vdc will be large. When the rotational speed Vg decreases, the power generated by the generator 2 decreases, meaning that when a speed at which the rotational speed Vg decreases is high, it can be predicted that the drop of the direct current voltage Vdc will be large.

When the derivative value of the detected value of the generator temperature Tg rises above a temperature determination value preset to be a positive value, the voltage drop predicting unit 33 determines that it is predicted that the drop of the direct current voltage Vdc will be large. When the generator temperature Tg rises, a winding resistance increases, together with which a magnetic body flux decreases, because of which the power generated by the generator 2 decreases. This means that when a speed at which the generator temperature Tg rises is high, it can be predicted that the drop of the direct current voltage Vdc will be large.

Alternatively, the voltage drop predicting unit 33 may add a value that is the derivative value of the detected value of the direct current voltage Vdc multiplied by a prediction period to the detected value of the direct current voltage Vdc, thereby calculating a predicted value of the direct current voltage Vdc, and determine that the drop of the direct current voltage Vdc will be large when the predicted value of the direct current voltage Vdc drops below the target voltage Vdco.

Also, the voltage drop predicting unit 33 may add a value that is the derivative value of the detected value of the rotational speed Vg multiplied by a prediction period and a conversion constant to the detected value of the direct current voltage Vdc, thereby calculating a predicted value of the direct current voltage Vdc, and determine that the drop of the direct current voltage Vdc will be large when the predicted value of the direct current voltage Vdc drops below the target voltage Vdco.

Also, the voltage drop predicting unit 33 may add a value that is the derivative value of the detected value of the generator temperature Tg multiplied by a prediction period and a conversion constant to the detected value of the direct current voltage Vdc, thereby calculating a predicted value of the direct current voltage Vdc, and determine that the drop of the direct current voltage Vdc will be large when the predicted value of the direct current voltage Vdc drops below the target voltage Vdco.

When an end determination time ΔTend elapses after determining that a voltage drop prediction time control is to be executed, the voltage drop predicting unit 33 determines that the execution of the voltage drop prediction time control is to be ended when the detected value of the direct current voltage Vdc has exceeded an end determination voltage Vend, or when the detected value of the direct current voltage Vdc has dropped below the target voltage Vdco before being increased set by the target voltage receiving and setting unit 31.

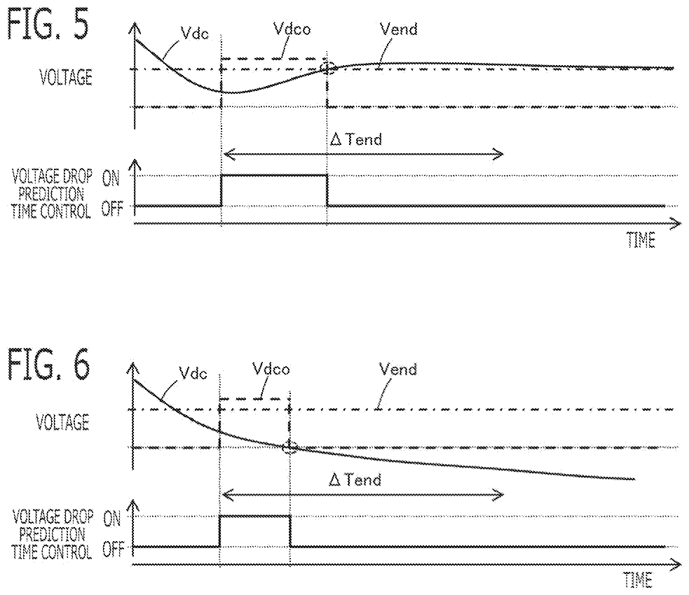

FIG. 4 shows an example of an end determination according to the end determination time ΔTend. According to an end determination according to the end determination time ΔTend, a voltage drop prediction time control can be prevented from being continued when the direct current voltage Vdc is in a stable state. FIG. 5 shows an example of an end determination according to the end determination voltage Vend. According to an end determination according to the end determination voltage Vend, a voltage drop prediction time control that has become unnecessary can be caused to end when the direct current voltage Vdc rises. FIG. 6 shows an example of an end determination according to the target voltage Vdco before being increased. According to an end determination according to the target voltage Vdco before being increased, a voltage drop prediction time control can be ended, and a normal control caused to be executed, when a drop of the direct current voltage Vdc cannot be preemptively restricted by the voltage drop prediction time control.

### Target Voltage Correcting Unit 34

When it is determined by the voltage drop predicting unit 33 that a voltage drop prediction time control is to be executed, the target voltage correcting unit 34 causes the target voltage Vdco set by the target voltage receiving and setting unit 31 to increase. A target voltage increase amount ΔVdco is preset. Meanwhile, when it is determined by the voltage drop predicting unit 33 that a voltage drop prediction time control is not to be executed, the target voltage correcting unit 34 does not cause the target voltage Vdco set by the target voltage receiving and setting unit 31 to increase.

This configuration is such that when it is predicted that the drop of the direct current voltage Vdc will be large, power can be caused to be generated forcibly, and the drop of the direct current voltage Vdc can be restricted preemptively, by the target voltage Vdco being caused to increase.

### Rotational Speed Determining Unit 35

When the detected value of the rotational speed Vg is equal to or lower than a preset excitation execution determination value, the rotational speed determining unit 35 determines that a rotational speed condition for executing an excitation control has been fulfilled, and when the detected value of the rotational speed Vg is greater than the excitation execution determination value, the rotational speed determining unit 35 determines that the rotational speed condition for executing an excitation control has not been fulfilled. Details will be described hereafter, but the duty ratio Don is gradually increased during the excitation time Tin under an excitation control.

In order that an excitation control is executed when the engine is idling, the excitation execution determination value is set to be a rotational speed higher than a rotational speed region in which idling is executed. When the duty ratio Don is increased sharply when the engine is idling, the regenerative torque of the generator 2 increases sharply, the rotational speed of the engine 4 fluctuates, and idling stability is lost. Therefore, an excitation control to be described hereafter is executed when the engine 4 is idling, the regenerative torque of the generator 2 is caused to increase gently, and fluctuation of the engine rotational speed is restricted.

### Excitation Time Correcting Unit 36

When an excitation control is executed, the excitation time correcting unit 36 causes the excitation time Tin set by the excitation time receiving and setting unit 32 to change based on the detected value of the direct current voltage Vdc, the detected value of the rotational speed Vg, and the detected value of the generator temperature Tg.

According to this configuration, an appropriate excitation time Tin such that a drop of the direct current voltage Vdc can be restricted, while restricting a decrease of the rotational speed Vg, can be set by causing the excitation time Tin to change based on the detected value of the direct current voltage Vdc, the detected value of the rotational speed Vg, and the detected value of the generator temperature Tg.

In the present embodiment, as heretofore described, the excitation time Tin (hereafter also called a reference excitation time Tin0) indicated by an excitation time command value received from the external control device changes stepwisely. Further, the excitation time correcting unit 36, based on the detected value of the direct current voltage Vdc, the detected value of the rotational speed Vg, and the detected value of the generator temperature Tg, causes the excitation time Tin to change within a range between an excitation time TinL, which is one step shorter than the reference excitation time Tin0 set by the excitation time receiving and setting unit. 32, and an excitation time TinH, which is one step longer.

This configuration is such that even when the reference excitation time Tin0 received from the external control device stepwisely changes, the excitation time Tin is caused to change finely within the range between the excitation time TinL, which is one step shorter, and the excitation time TinH, which is one step longer, whereby control accuracy can be increased.

For example, the excitation time correcting unit 36 sets two excitation times, indicated by a command value caused to increase by 1 bit and a command value caused to decrease by 1 bit from a received excitation time command value, as the excitation time TinL, which is one step shorter, and the excitation time TinH, which is one step longer. Alternatively, the excitation time correcting unit 36 may set a value that is one step's worth of time ΔT subtracted from the reference excitation time Tin0 as the excitation time TinL, which is one step shorter, and set a value that is one step's worth of time ΔT added to the reference excitation time Tin0 as the excitation time TinH, which is one step longer.

In the present embodiment, the excitation time correcting unit 36 sets an excitation time candidate value Tintmp based on the detected value of the direct current voltage Vdc, the detected value of the rotational speed Vg, and the detected value of the generator temperature Tg. For example, the excitation time correcting unit 36 refers to candidate value map data wherein a relationship between the direct current voltage Vdc, the rotational speed Vg, and the generator temperature Tg and the excitation time candidate value Tintmp is preset, and sets the excitation time candidate value Tintmp corresponding to the current detected value of the direct current voltage Vdc, detected value of the rotational speed Vg, and detected value of the generator temperature Tg. For example, the need to cause generated power to increase decreases as the direct current voltage Vdc increases, because of which the excitation time candidate value Tintmp is lengthened. The excitation time candidate value Tintmp is lengthened in order to restrict a further decrease of the rotational speed Vg as the rotational speed Vg decreases. The need to cause generated power to increase increases as the generator temperature Tg increases, because of which the excitation time candidate value Tintmp is shortened. The candidate value map data is set by the direct current voltage Vdc factor, the rotational speed Vg factor, and the generator temperature Tg factor being considered comprehensively.

Further, when the excitation time candidate value Tintmp is within the range between the excitation time TinL, which is one step shorter, and the excitation time TinH, which is one step longer, as shown in the following equation, the excitation time correcting unit. 36 sets the excitation time candidate value Tintmp as the final excitation time Tin. Meanwhile, when the excitation time candidate value Tintmp is outside the range between the excitation time TinL, which is one step shorter, and the excitation time TinH, which is one step longer, the excitation time correcting unit 36 sets the reference excitation time Tin0 set by the excitation time receiving and setting unit 32 as the final excitation time Tin.

### 1) When TinL<Tintmp<TinH,

Tin=Tintmp

### 2) When Tintmp≤TinL, or TinH≤Tintemp,

Tin=Tin0 (1)

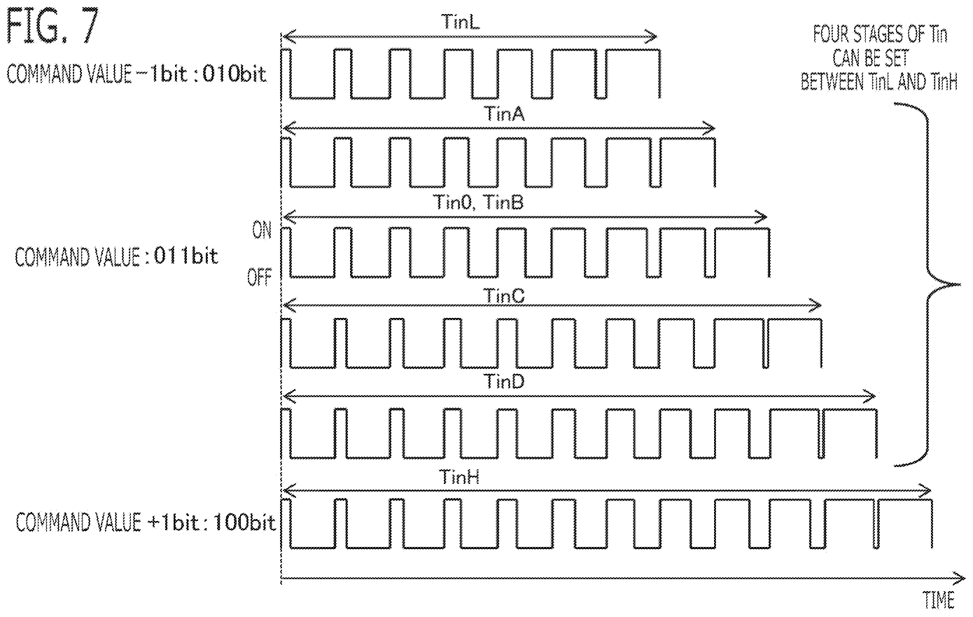

FIG. 7 illustrates an example relating to an excitation time setting by the excitation time correcting unit 36. In the present example, an excitation time command value is 011 bits, and a rectangular pulse wave such that the duty ratio Don gradually increases during the reference excitation time Tin0 indicated by 011 bits is shown in FIG. 7. Also, a rectangular pulse wave such that the duty ratio Don gradually increases during the excitation time TinL, which is one step shorter, indicated by a command value 010 bits caused to decrease by 1 bit from the excitation time command value 011 bits, and a rectangular pulse wave such that the duty ratio Don gradually increases during the excitation time TinH, which is one step longer, indicated by a command value 100 bits caused to increase by 1 bit from the excitation time command value 011 bits, are shown in FIG. 7.

In the present embodiment, as shown in FIG. 7, the excitation time correcting unit 36 can set four excitation times TinA, TinB, TinC, and TinD, which stepwisely change in still finer time intervals, between the excitation time TinL, which is one step shorter, and the excitation time TinH, which is one step longer. When the excitation time candidate value Tintmp set based on the detected value of the direct current voltage Vdc and the like is one of the four excitation times TinA, TinB, TinC, and TinD, the excitation time candidate value Tintmp is set as the final excitation time Tin. When the excitation time candidate value Tintmp is none of the four excitation times TinA, TinB, TinC, and TinD, the reference excitation time Tin0 indicated by the excitation time command value 011 bits is set as the final excitation time Tin.

### Excitation Control Unit 37

When it is determined that the excitation control rotational speed condition has been fulfilled, and determined that a voltage drop prediction time control is to be executed, the excitation control unit 37 generates a rectangular pulse wave such that the duty ratio Don gradually increases during the excitation time Tin.

This configuration is such that when it is predicted that a drop of the direct current voltage Vdc will be large, an excitation control is carried out, causing the duty ratio Don to gradually increase, whereby the amount of power generated can be caused to gradually increase, and the drop of the direct current voltage Vdc can be preemptively restricted while restricting a decrease of the rotational speed Vg.

After starting an excitation control, the excitation control unit 37 causes the duty ratio Don to gradually increase during the excitation time Tin from a start time duty ratio Dons (for example, 15%) to an end time duty ratio Done (for example, 85%). An increased speed of the duty ratio Don is set to be a value that is a duty deviation, which is the start time duty ratio Dons subtracted from the end time duty ratio Done, divided by the excitation time Tin (=(Done−Dons)/Tin). The start time duty ratio Dons and the end time duty ratio Done may be included in command values transmitted from the external control device, or may be preset in the control circuit 30.

The excitation control unit 37 generates a duty ratio Don rectangular pulse wave using PWM (Pulse Width Modulation) control. That is, the excitation control unit 37 causes the duty ratio Don of a rectangular pulse wave in a preset PWM control cycle to change. The generated rectangular pulse wave is output to the on/off circuit 54. Further, as heretofore described, an energization of the field winding 22 is turned on and off in accordance with a turning on and off of the rectangular pulse wave. When the rectangular pulse wave is in an on-state (high), energization of the field winding 22 is in an on-state, and when the rectangular pulse wave is in an off-state (low), energization of the field winding 22 is in an off-state.

When the excitation time Tin elapses after starting the excitation control, the excitation control unit 37 ends the excitation control, and causes a voltage control by the voltage control unit 38 to be executed.

When an excitation time command value received from the external control device is a command value such that an excitation control is not to be carried out (for example, 000 bits), the excitation control unit 37 does not execute an excitation control.

Meanwhile, when it is determined that the excitation control rotational speed condition has been fulfilled, and determined that a voltage drop prediction time control is not to be executed, the excitation control unit 37 generates a rectangular pulse wave such that the duty ratio Don gradually increases during the excitation time Tin when the detected value of the direct current voltage Vdc drops below the target voltage Vdco.

### Voltage Control Unit 38

When it is determined that the excitation control rotational speed condition has not been fulfilled, and determined that a voltage drop prediction time control is to be executed, the voltage control unit 38 causes the duty ratio Don that turns on an energization of the field winding 22 included in the generator 2 to change in such a way that the detected value of the direct current voltage Vdc nears the target voltage Vdco increased by the target voltage correcting unit 34.

This configuration is such that when it is predicted that a drop of the direct current voltage Vdc will be large, the drop of the direct current voltage Vdc can be preemptively restricted by carrying out a voltage control based on the increased target voltage Vdco, thereby causing the duty ratio Don to increase.

The voltage control unit 38 carries out feedback control causing the duty ratio Don to increase when the detected value of the direct current voltage Vdc is lower than the target voltage Vdco, and causing the duty ratio Don to decrease when the detected value of the direct current voltage Vdc is higher than the target voltage Vdco. Further, the voltage control unit 38 generates a duty ratio Don rectangular pulse wave using PWM control. The generated rectangular pulse wave is output to the on/off circuit 54.

Meanwhile, when it is determined that the excitation control rotational speed condition has not been fulfilled, and determined that a voltage drop prediction time control is not to be executed, and the detected value of the direct current voltage Vdc has dropped below the target voltage Vdco, the voltage control unit 38 causes the duty ratio Don to change in such a way that the detected value of the direct current voltage Vdc nears the target voltage Vdco.

### Flowchart

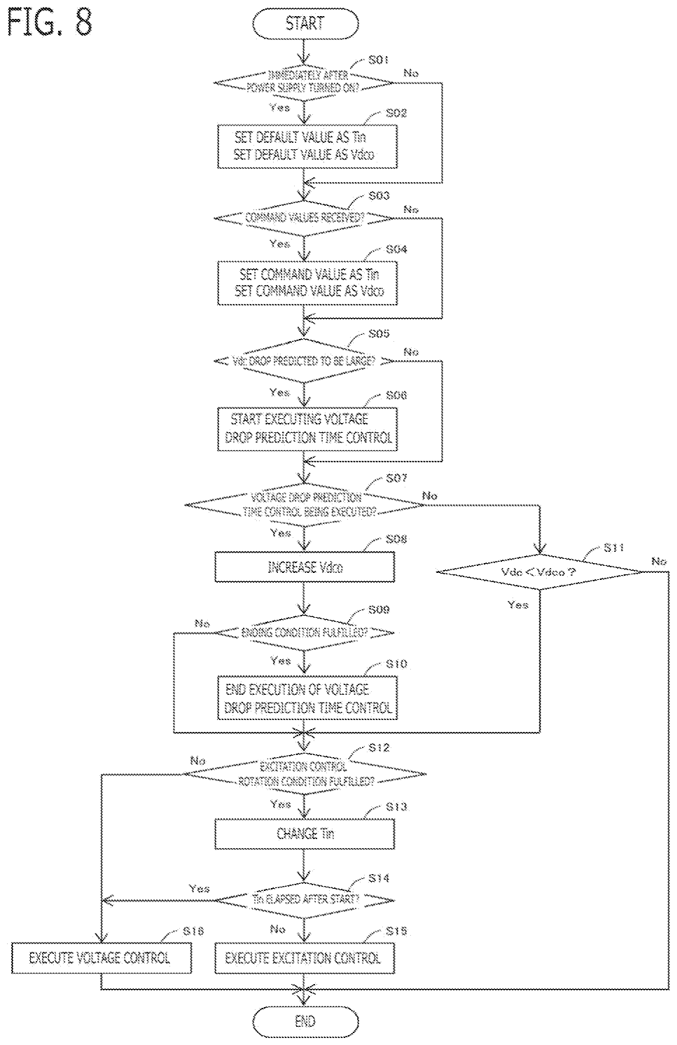

A process of the heretofore described generator control device 1 can be configured as shown in a flowchart of FIG. 8. The process of FIG. 8 is executed, for example, every predetermined calculation cycle.

In step S01, the excitation time receiving and setting unit 32 determines whether or not a current time is a time immediately after a vehicle power supply is turned on and a power supply of the generator control device 1 is turned on, proceeds to step S02 when the current time is a time immediately after the power supplies are turned on, and proceeds to step S03 when the current time is not a time immediately after the power supplies are turned on. In step S02, the excitation time receiving and setting unit 32 sets a preset default value as the excitation time Tin. Also, the target voltage receiving and setting unit 31 sets a preset default value as the target voltage Vdco.

In step S03, the excitation time receiving and setting unit 32 determines whether or not a command value has been received from the external control device (in the present example, the engine control device 42) via the communication circuit 53, proceeds to step S04 when a command value has been received, and proceeds to step S05 when no command value has been received. In step S04, the excitation time receiving and setting unit 32 sets the excitation time Tin indicated by the received excitation time command value. Also, the target voltage receiving and setting unit 31 sets the target voltage Vdco indicated by the target voltage command value.

In step S05, as heretofore described, the voltage drop predicting unit 33 determines whether or not it is predicted that a drop of the direct current voltage Vdc will be large based on the detected value of the direct current voltage Vdc, the detected value of the rotational speed Vg, and the detected value of the generator temperature Tg, proceeds to step S06 when it is predicted that the drop of the direct current voltage Vdc will be large, and proceeds to step S07 when it is not predicted that the drop of the direct current voltage Vdc will be large. In step S06, the voltage drop predicting unit 33 determines that a voltage drop prediction time control is to be executed.

In step S07, the target voltage correcting unit 34 determines whether or not it has been determined that a voltage drop prediction time control is to be executed, proceeds to step S08 when it has been determined that a voltage drop prediction time control is to be executed, and proceeds to step S11 when it has not been determined that a voltage drop prediction time control is to be executed.

In step S08, as heretofore described, the target voltage correcting unit 34 causes the target voltage Vdco set by the target voltage receiving and setting unit 31 to increase.

Further, as heretofore described, when it is determined in step S09 that the end determination time ΔTend has elapsed after determining that a voltage drop prediction time control is to be executed, the voltage drop predicting unit 33 proceeds to step S10 when the detected value of the direct current voltage Vdc has exceeded the end determination voltage Vend, or when the detected value of the direct current voltage Vdc has dropped below the target voltage Vdco before being increased set by the target voltage receiving and setting unit 31, and proceeds to step S12 in any other case. In step S10, the voltage drop predicting unit 33 determines that the execution of the voltage drop prediction time control is to be ended.

Meanwhile, when it has not been, determined that a voltage drop prediction time control is to be executed, the voltage drop predicting unit. 33 determines in step S11 whether or not the detected value of the direct current voltage Vdc has dropped below the target voltage Vdco, which has not been increased, proceeds to step S12 and causes an excitation control or a voltage control to be executed when the detected value of the direct current voltage Vdc has dropped below the target voltage Vdco, and ends the process when the detected value of the direct current voltage Vdc has not dropped below the target voltage Vdco.

In step S12, as heretofore described, the rotational speed determining unit 35 determines that a rotational speed condition for executing an excitation control has been fulfilled, and proceeds to step S13, when the detected value of the rotational speed Vg is equal to or lower than a preset excitation execution determination value, and determines that the rotational speed condition for executing an excitation control has not been fulfilled, and proceeds to step S16, when the detected value of the rotational speed Vg is greater than the excitation execution determination value.

In step S13, as heretofore described, the excitation time correcting unit 36 causes the excitation time Tin set by the excitation time receiving and setting unit 32 to change based on the detected value of the direct current voltage Vdc, the detected value of the rotational speed Vg, and the detected value of the generator temperature Tg.

In step S14, the rotational speed determining unit 35 determines whether or not the excitation time Tin has elapsed after starting the excitation control, proceeds to step S16 when the excitation time Tin has elapsed, and proceeds to step S15 when the excitation time Tin has not elapsed.

In step S15, as heretofore described, the excitation control unit 37 executes an excitation control, generating a rectangular pulse wave such that the duty ratio Don gradually increases during the excitation time Tin. The generated rectangular pulse wave is input into the on/off circuit 54. The on/off circuit 54 turns an energization of the field winding 22 on and off in accordance with a turning on and off of the rectangular pulse wave.

Meanwhile, as heretofore described, when it has been determined that an excitation control is not to be executed, the voltage control unit 38, in step S16, causes the duty ratio Don that turns on an energization of the field winding 22 included in the generator 2 to change in such a way that the detected value of the direct current voltage Vdc nears the target voltage Vdco. The generated rectangular pulse wave is input into the on/off circuit 54. The on/off circuit 54 turns an energization of the field winding 22 on and off in accordance with a turning on and off of the rectangular pulse wave.

When neither an excitation control nor a voltage control is to be executed, the control circuit 30 may set the duty ratio Don to 0 and not cause the generator 2 to carry out a power generation, or may set the duty ratio Don to a default value greater than 0, and cause the generator 2 to carry out a power generation.

### Control Behavior

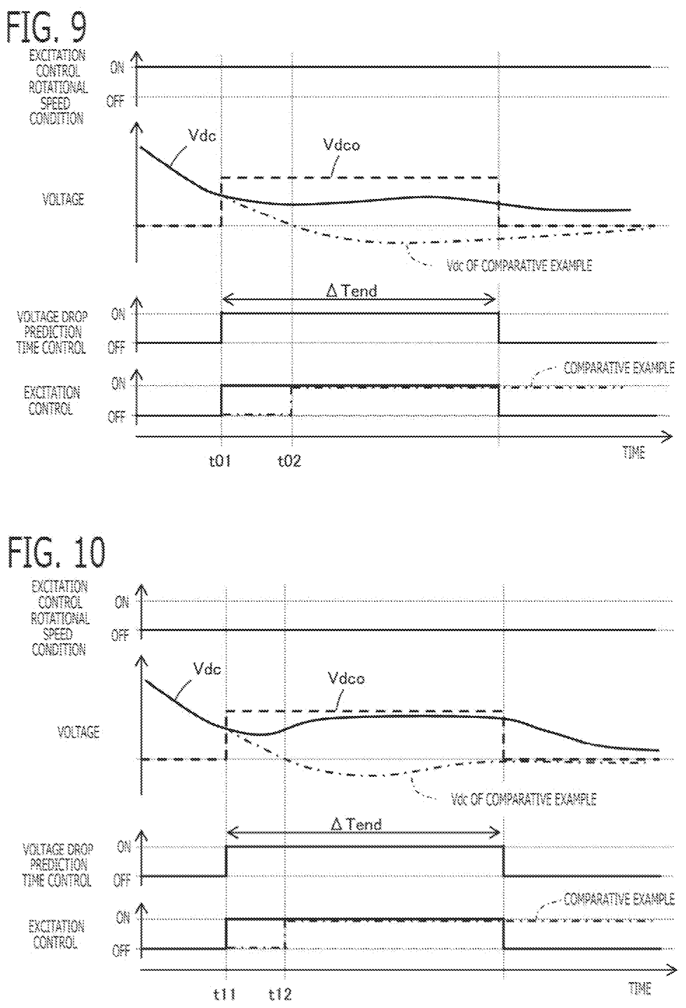

Examples of control behavior are shown in FIG. 9 and FIG. 10. Control behavior according to a comparative example, in which the control when executing a voltage drop prediction time control according to the present embodiment is not carried out, is also shown as a dashed-dotted line in FIG. 9 and FIG. 10.

In the example of FIG. 9, it has been determined by the rotational speed determining unit 35 that the excitation control rotational speed condition has been fulfilled. As it has been predicted based on the detected value of the direct current voltage Vdc and the like that a drop of the direct current voltage Vdc will be large, the voltage drop predicting unit 33 determines at a time t01 that a voltage drop prediction time control is to be executed. Further, the target voltage correcting unit 34 causes the target voltage Vdco set by the target voltage receiving and setting unit 31 to increase at the time t01.

As it has been determined that the excitation control rotational speed condition has been fulfilled, and has been determined that a voltage drop prediction time control is to be executed, the excitation control unit 37 starts an excitation control at the time t01, and generates a rectangular pulse wave such that the duty ratio Don gradually increases during the excitation time Tin. Also, as an excitation control is to be executed, the excitation time correcting unit. 36 causes the excitation time Tin set by the excitation time receiving and setting unit 32 to change based on the detected value of the direct current voltage Vdc, the detected value of the rotational speed Vg, and the detected value of the generator temperature Tg.

Meanwhile, the comparative example is such that, even after the time t01, an excitation control is not started until the detected value of the direct current voltage Vdc drops below the target voltage Vdco, which has been set by the target voltage receiving and setting unit 31 and has not been increased, at a time t02.

The present embodiment is such that when it is predicted that a drop of the direct current voltage Vdc will be large, an excitation control is caused to start early, and the duty ratio Don is caused to increase gradually, whereby the amount of power generated can be caused to increase gradually, because of which the drop of the direct current voltage Vdc can be preemptively restricted while restricting a decrease of the rotational speed Vg. Meanwhile, in the comparative example, an excitation control is not started until the detected value of the direct current voltage Vdc drops below the target voltage Vdco, which has not been increased, because of which the drop of the direct current voltage Vdc increases.

In the example of FIG. 10, it has been determined by the rotational speed determining unit 35 that the excitation control rotational speed condition has not been fulfilled. As it has been predicted based on the detected value of the direct current voltage Vdc and the like that a drop of the direct current voltage Vdc will be large, the voltage drop predicting unit 33 determines at a time t11 that a voltage drop prediction time control is to be executed. Further, the target voltage correcting unit 34 causes the target voltage Vdco set by the target voltage receiving and setting unit 31 to increase at the time t11.

As it has been determined that the excitation control rotational speed condition has not been fulfilled, and has been determined that a voltage drop prediction time control is to be executed, the excitation control unit 37 starts a voltage control at the time t11, causes the duty ratio Don to change in such a way that the detected value of the direct current voltage Vdc nears the target voltage Vdco increased by the target voltage correcting unit 34, and generates a duty ratio Don rectangular pulse wave.

Meanwhile, the comparative example is such that, even after the time t1l, a voltage control is not started until the detected value of the direct cur rent voltage Vdc drops below the target voltage Vdco, which has been set by the target voltage receiving and setting unit 31 and has not been increased, at a time t12.

The present embodiment is such that when it is predicted that a drop of the direct current voltage Vdc will be large, the target voltage Vdco is caused to increase, and a voltage control is caused to start early, because of which the duty ratio Don is caused to increase, whereby the amount of power generated can be caused to increase. Therefore, the drop of the direct current voltage Vdc can be preemptively restricted. Meanwhile, in the comparative example, the duty ratio Don cannot be caused to increase until the detected value of the direct current voltage Vdc drops below the target voltage Vdco, which has not been increased, because of which the drop of the direct current voltage Vdc increases.

Although the present disclosure is described above in terms of an exemplary embodiment, it should be understood that the various features, aspects and functionality described in the embodiment are not limited in their applicability to the particular embodiment with which they are described, but instead can be applied, alone or in various combinations to the embodiment. It is therefore understood that numerous modifications which have not been exemplified can be devised without departing from the scope of the present disclosure. For example, at least one of the constituent components may be modified, added, or eliminated.

1. A generator control device that controls a generator that generates direct current power, the generator control device comprising:
a voltage detecting circuit that detects a direct current voltage output from the generator;
a rotational speed detecting circuit that detects a rotational speed of the generator;
a temperature detecting circuit that detects a temperature of the generator;
a communication circuit that carries out communication with an external control device;
a target voltage receiving setter that sets a target voltage indicated by a command value received from the external control device;
an excitation time receiving setter that sets an excitation time indicated by a command value received from the external control device;
a voltage drop predictor that determines that a voltage drop prediction time control is to be executed when it is predicted, based on a detected value of the direct current voltage, a detected value of the rotational speed, and a detected value of the temperature, that a drop of the direct current voltage will be large;
a target voltage corrector that causes the target voltage set by the target voltage receiving setter to increase when it has been determined that the voltage drop prediction time control is to be executed;
a rotational speed determiner that determines that a rotational speed condition for executing an excitation control has been fulfilled when the detected value of the rotational speed is equal to or lower than a preset excitation execution determination value, and determines that the rotational speed condition for executing the excitation control has not been fulfilled when the detected value of the rotational speed is greater than the excitation execution determination value;
an excitation time corrector that causes the excitation time set by the excitation time receiving setter to change based on the detected value of the direct current voltage, the detected value of the rotational speed, and the detected value of the temperature;
an excitation controller that generates a rectangular pulse wave such that a duty ratio that turns on an energization of a field winding included in the generator increases gradually during the excitation time when it has been determined that the excitation control rotational speed condition has been fulfilled, and has been determined that the voltage drop prediction time control is to be executed;
a voltage controller that causes the duty ratio to change in such a way that the detected value of the direct current voltage nears the target voltage increased by the target voltage corrector when it has been determined that the excitation control rotational speed condition has not been fulfilled, and has been determined that the voltage drop prediction time control is to be executed, and generates a rectangular pulse wave of the duty ratio; and
an on/off circuit that turns an energization of the field winding on and off in accordance with a turning on and off of the rectangular pulse wave generated by the excitation controller or the voltage controller.

2. The generator control device according to claim 1, wherein the excitation time indicated by a command value received from the external control device changes stepwisely, and
the excitation time corrector causes the excitation time to change, based on the detected value of the direct current voltage, the detected value of the rotational speed, and the detected value of the temperature, within a range between an excitation time that is one step shorter and an excitation time that is one step longer than the excitation time set by the excitation time receiving setter.

3. The generator control device according to claim 2, wherein the excitation time corrector sets an excitation time candidate value based on the detected value of the direct current voltage, the detected value of the rotational speed, and the detected value of the temperature,
sets the excitation time candidate value as the final excitation time when the excitation time candidate value is within the range between the excitation time that is one step shorter and the excitation time that is one step longer, and
sets the excitation time set by the excitation time receiving setter as the final excitation time when the excitation time candidate value is outside the range between the excitation time that is one step shorter and the excitation time that is one step longer.

4. The generator control device according to claim 1, wherein the voltage drop predictor determines whether or not it is predicted that a drop of the direct current voltage will be large based on a derivative value of the detected value of the direct current voltage, a derivative value of the detected value of the rotational speed, and a derivative value of the detected value of the temperature.

5. The generator control device according to claim 1, wherein the voltage drop predictor, after determining that the voltage drop prediction time control is to be executed, determines that the execution of the voltage drop prediction time control is to be ended when an end determination time elapses, when the detected value of the direct current voltage exceeds an end determination voltage, or when the detected value of the direct current voltage drops below the target voltage before being increased set by the target voltage receiving setter.

6. The generator control device according to claim 1, wherein, when it has been determined that the excitation control rotational speed condition has been fulfilled, and has been determined that the voltage drop prediction time control is not to be executed, and the detected value of the direct cur rent voltage has dropped below the target voltage, the excitation controller generates a rectangular pulse wave such that the duty ratio changes gradually during the excitation time, and
when it has been determined that the excitation control rotational speed condition has not been fulfilled, and has been determined that the voltage drop prediction time control is not to be executed, and the detected value of the direct current voltage has dropped below the target voltage, the voltage controller causes the duty ratio to change in such a way that the detected value of the direct current voltage nears the target voltage, and generates a rectangular pulse wave of the duty ratio.
